(19) United States
(12) Patent Application Publication
(10) Pub. No.: US 2011/0317243 A1
(43) Pub. Date: Dec. 29, 2011

(54) ELECTRICALLY CONTROLLABLE DEVICE HAVING UNIFORM COLORING/BLEACHING OVER THE ENTIRE SURFACE

(75) Inventors: Fabienne Piroux, Compiegne (FR); Emmanuel Valentin, Le Plessis Trevise (FR); Samuel Dubrenat, Paris (FR); Gilles Bokobza, Paris (FR)

(73) Assignee: SAINT-GOBAIN GLASS FRANCE, Courbevoie (FR)

(21) Appl. No.: 13/203,784

(22) PCT Filed: Mar. 2, 2010
(86) PCT No.: PCT/EP2010/052620

§ 371 Date: Sep. 14, 2011

(30) Foreign Application Priority Data
Mar. 2, 2009 (FR) 0951309

(51) Int. Cl. G02F 1/153

(52) U.S. Cl. 359/275

(57) ABSTRACT

A device including a multilayer stack of: a first substrate having a glass function; a first electronically conductive layer with an associated current lead; an electroactive system; a second electronically conductive layer with an associated current lead; and a second substrate having a glass function. Each of the electronically conductive layers has a resistance per unit area enabling it to have an equipotential surface in coloring mode and bleaching mode, and each having a variable resistance that gradually decreases from the periphery toward the interior of the electrically controllable device by choosing the resistance at the center of the glazing, in the zone or zones furthest away from the current leads, so that the ohmic drop over the central surface of the substrates of the glazing, in the zone or zones furthest away from the current leads, is at most equal to 5% of the voltage applied across the terminals of the device.

The present invention relates to an electrically controllable device having variable optical/energy properties, comprising the following multilayer stack:
a first substrate (V₁) having a glass function;
a first electronically conductive layer (TCC₁) with an associated current lead;
an electroactive system (EA) comprising or formed by:
   at least one electroactive organic compound (ea₁⁺) capable of being reduced and/or of accepting electrons and cations acting as compensating charges;
   at least one electroactive organic compound (ea₂) capable of being oxidized and/or of ejecting electrons and cations acting as compensating charges,
at least one of said electroactive organic compounds (ea₁⁺ and ea₂) being electrochromic in order to obtain a color contrast; and
   ionic charges capable, under the action of an electrical current, of causing said electroactive organic compounds (ea₁⁺ and ea₂) to undergo oxidation and reduction reactions, these being necessary in order to obtain the color contrast;
a second electronically conductive layer (TCC₂) with an associated current lead; and
a second substrate (V₂) having a glass function.

The electronically conductive layers are denoted by “TCC”, the abbreviation for “transparent conductive coating”, one example of which is a transparent conductive oxide or TCO.

The electroactive medium (EA) is a medium in solution or a gelled medium. It may also be contained in a self-supporting polymer matrix, as described in International Application PCT/FR2008/051160 filed on 25 Jun. 2008 or in European Patent Application EP 1 786 883.

If the two electroactive materials are electrochromic materials, these may be identical or different. If one of the electroactive materials is electrochromic and the other is not, the latter will act as counter-electrode not participating in the coloring and bleaching processes of the system.

Assuming that the compound (ea₁⁺) is electrochromic (for example being 1,1′-diethyl-4,4′-bipyridinium diperchlorate) and assuming that the compound (ea₂) is electrochromic (for example being 5,10-dihydro-5,10-dimethylphenazine) or nonelectrochromic (for example being a ferrocene), the redox reactions that are set up under the action of the electrical current are the following:

ea₁⁺+e⁻→ea₁
(colored)
   and

ea₂≡ea₂⁺+e⁻
(colored if electrochromic but colorless if not electrochromic)

In such known devices and in accordance with a first prior art, as illustrated by FIGS. 1 to 3 described in detail below, each current lead consists of a thin conductive strip applied along a border of the associated electronically conductive layer, the two strips being located along two opposed borders of the electrically controllable device.

In this case, and for small glazing, such as rearview mirrors for example, the transition from the bleached state to the bleached state may take place uniformly.

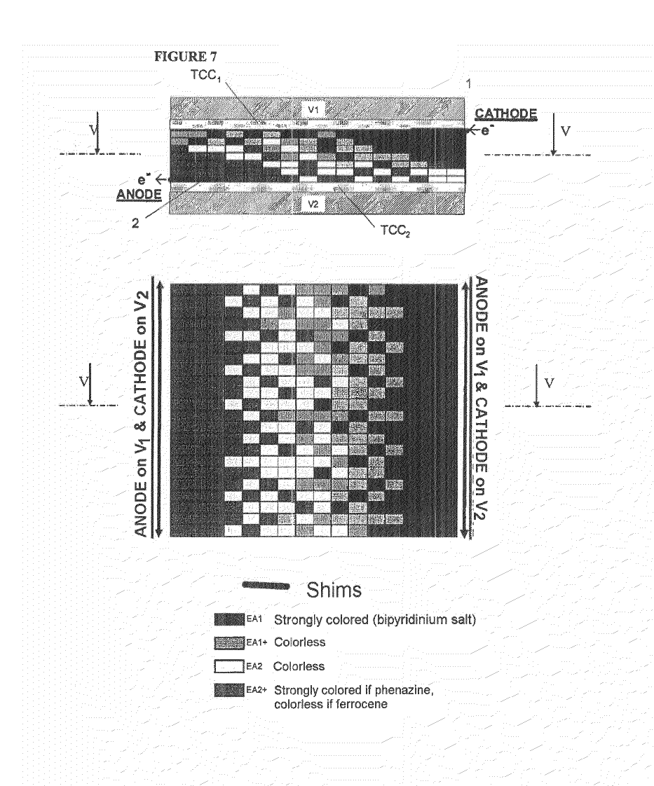

In contrast, for glazing larger in size, such as architectural glazing, the transition from the bleached state to the bleached state takes place with a curtain effect consisting in having coloration that starts at only one or at both of the two current leads and then propagates through the rest of the glazing. This is illustrated schematically in FIG. 7 of the appended drawing.

Moreover, for such large glazing, during the coloration step, but also when the colored state is at a maximum, the absorption of the glazing will be greater with one or the two current leads than that away from these current leads.

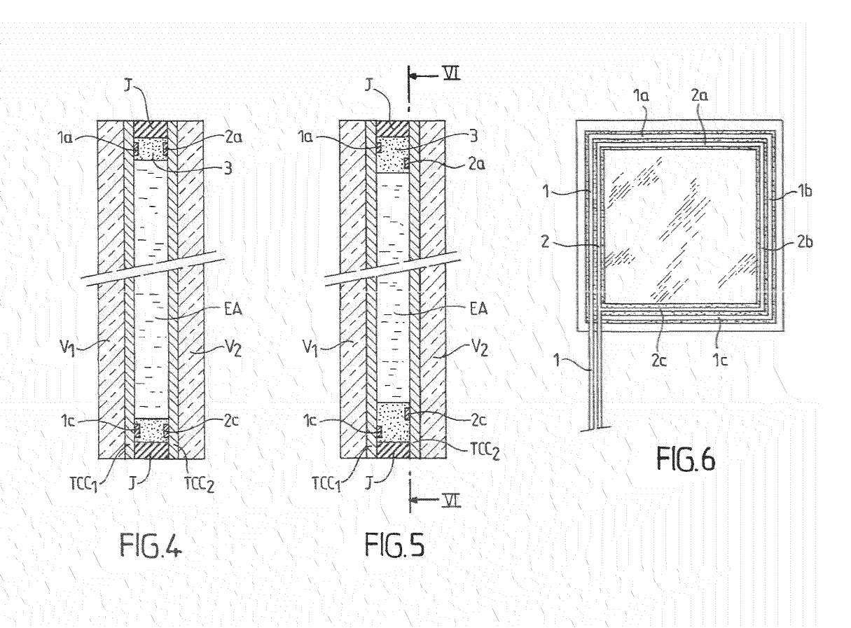

In accordance with a second prior art, represented by French Patent Application filed on May 12, 2008 under the number 08/58289 in the name of the Applicant company and having as title “Dispositif électrocommandable présentant un acheminement amélioré des charges électriques en milieu électro-actif [Electrically controllable device having improved flow of electrical charges in an electroactive medium]”, the conductive strips used as current leads are applied to the entire perimeter of the conductive layers, which face or substantially face one another so as to avoid any color segregation when the electrochromic device is kept for a long time in the colored state. FIGS. 4 and 5 below illustrate glazing according to this second prior art document.

As in the previous case, the transition from the bleached state to the colored state may take place uniformly for small glazing.

In contrast, for glazing of large size, the transition from the bleached state to the colored state will be accompanied by a halo effect in which the coloration starts at the current leads. This is what is illustrated in FIG. 9 of the appended drawing.

Here again, for such large glazing, during the coloration step, but also when the colored state is at a maximum, the absorption of the glazing will be larger at the periphery of the glazing, at the place where the current leads are, than at the center of this glazing.

The applicant company has therefore sought an effective means for eliminating the curtain or halo effects during the electrochromic glazing coloration process and for ensuring uniform absorption over the entire surface of electrochromic glazing both in the colored and bleached states, and during the coloration and bleaching steps, irrespective of the size of this glazing.

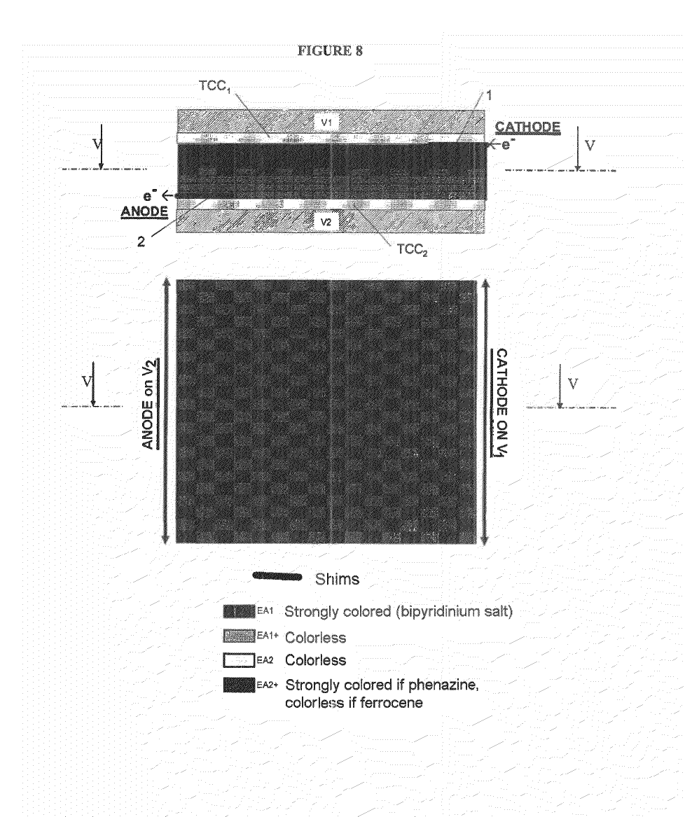

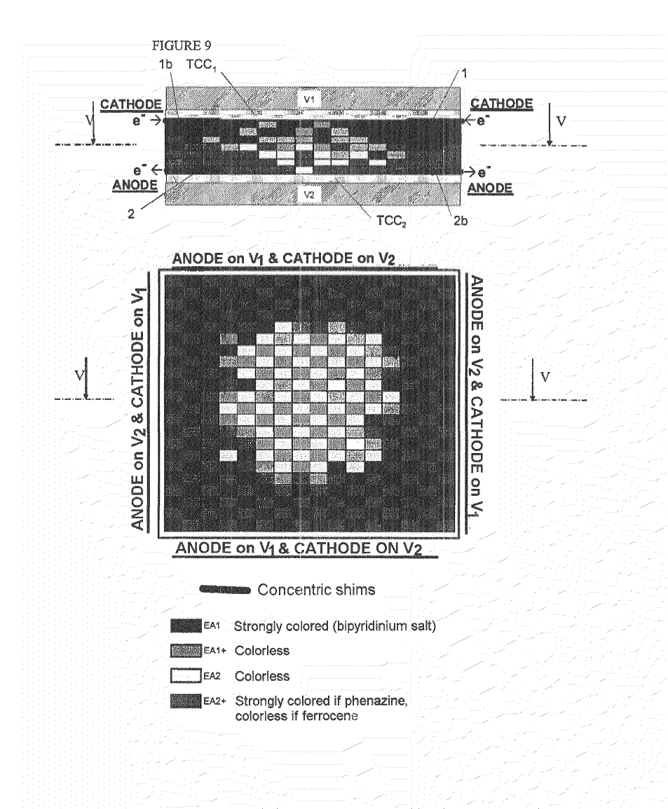

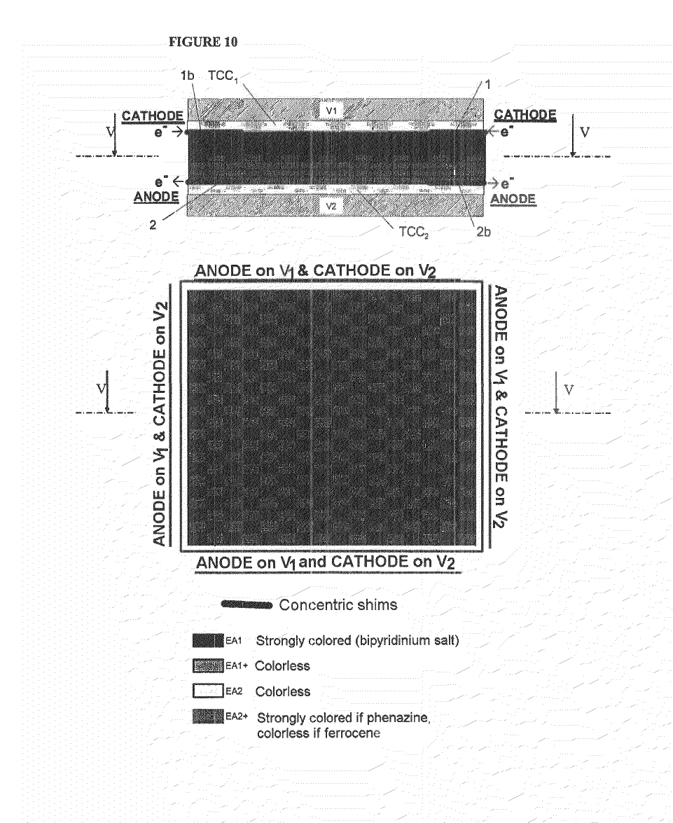

These objectives have been achieved according to the present invention by the use of conductive layers that are specifically manufactured in order to limit the ohmic drop at the electrodes of electrochromic glazing. The results of the present invention may be seen by looking at FIGS. 7 and 8, which illustrate the elimination of the curtain effect and FIGS. 9 and 10 which illustrate the elimination of the halo effect.

The subject of the present invention is therefore an electrically controllable device having variable optical/energy properties, comprising the multilayer stack as defined right at the beginning of this description, characterized in that each of the layers TCC₁ and TCC₂ is chosen to have a resistance R_{□} per unit area enabling it to have an equipotential surface in coloring mode and bleaching mode, each of the layers TCC₁ and TCC₂ having a variable resistance R_{□} that gradually decreases from the periphery toward the interior of the electrically controllable device by choosing R_{□} at the center of the glazing, in the zone or zones furthest away from the current leads, so that the ohmic drop over the central surface of the substrates of the glazing, in the zone or zones furthest away from the current leads, is at most equal to 5% of the voltage applied across the terminals of the device.

This enables a uniform current distribution to be obtained, those parts of the TCCs that have lower resistivity acting as electron wells. The result obtained is that the halo phenomenon is avoided.

This is because the surface voltage V_{P} at a point P on one of the conductive layers is defined by the equation:

V_{P}=V_{applied}−iR

in which:
V_{applied} is the voltage applied to the conductive layer;
i is the current
R is the resistance of the layer defined by the equation:

R=ρL/A=ρL/(Wt)=R_{□}L/W

where:
ρ is the resistivity of the specimen;
L is its length;
A is its section, where A=Wt;
W is its width;
t is its thickness; and
R_{□} is the resistance per unit area, where R_{□}=ρ/t,
   the term iR being the ohmic drop.

Preferably, the two facing layers TCC₁ and TCC₂ are identical.

The layers TCC₁ and TCC₂ may have a variable resistance R_{□} that gradually decreases in a progressive manner along a gradient.

The grid or microgrid may be made of a metal, such as aluminum.

The layers TCC₁ and TCC₂ may have a variable resistance R_{□} that gradually decreases in zones.

Advantageously, a conductive layer TCC₁ or TCC₂ of variable resistance R has a resistance which goes from 20Ω/□ or more on the periphery to 5Ω/□ or less at the center of the layer.

A layer TCC₁ or TCC₂ may take the form of a continuous layer or the form of a grid or a microgrid, or else the form of grids or of a microgrid which is coated with a continuous layer.

A layer TCC₁ or TCC₂ having a variable resistance R may be obtained:
by a plasma, flame or ablation treatment of the material of said layer in order for the conductivity of said layer to be progressively degraded or to be degraded in zones;
by carrying out successive deposition operations, especially in a vacuum, in which conductive material is deposited on the glass substrate, the first deposition being carried out over the entire surface of the substrate, the next deposition then being carried out on a central region thereof, with masking of the peripheral region, and so on if other zones have to be formed, it being possible for the deposition operations other than the first one to be carried out in particular on circular regions so that the various zones of the layer are concentric zones, the center of which corresponds to that of the substrate;
or by an array of conductive and/or insulating features, whether identical or different, which are formed on at least one part of the conductive layer deposited on the substrate.

French Patent Application FR 2 875 669 describes such arrays of conductive and/or insulating features.

Thus, as indicated in the above application, it is possible to create an array of insulating or weakly conductive features in the conductive layer (TCC₁, TCC₂) and to form an array with conductive features by filling holes formed in the conductive layer (TCC₁, TCC₂) with a material more conductive than that of the latter, by producing the conductive layer (TCC₁, TCC₂) with local overthicknesses forming the array of features, said overthicknesses being sufficient to obtain the desired characteristics, or else by producing portions of a more conductive second layer (TCC₁, TCC₂), this second layer being deposited for example by sputtering on the layer covered beforehand with a mask. The conductive features are especially silver dots.

The electronically conductive layers TCC₁ and TCC₂ are especially metal layers, such as silver, gold, platinum or copper layers; transparent conductive oxide (TCO) layers, such as tin-doped indium oxide (In₂O₃:Sn or ITO), antimony-doped indium oxide (In₂O₃:Sb), fluorine-doped tin oxide (SnO₂:F) and aluminum-doped zinc oxide (ZnO:Al) layers; or multilayers of the TCO/metal/TCO type, the TCO and the metal being in particular chosen from those listed above; or multilayers of the NiCr/metal/NiCr type, the metal being especially chosen from those listed above.

The layers TCC₁ and TCC₂ may be each connected to a current lead formed by a conductive strip applied to the associated layer TCC₁ or TCC₂, it being possible for the conductive strip to be a metal, an alloy or an electrically conductive composite which is deposited directly on the substrate covered with its conductive layer or on a spacer separating the two spacer substrates using, for example, a vacuum deposition technique or a screen printing technique with a metal paste, or else which is soldered to the substrate covered with its conductive layer or on a spacer separating the two substrates or else which is bonded using an electrically conductive adhesive, it being possible for the conductive strip applied to a substrate to be continuous or to have discontinuous regions that are connected together and for it to be applied on all or part of each substrate.

The current leads in particular consist of continuous conductive strips applied to the layers TCC₁ and TCC₂ and placed over the entire perimeter or substantially over the entire perimeter of said conductive layers (TCC₁ and TCC₂).

The substrates having a glass function may be chosen from glass and transparent polymers, such as polymethyl methacrylate (PMMA), polycarbonate (PC), polyethylene terephthalate (PET), polyethylene naphthoate (PEN) and cyclosporine copolymers (COCs).

Moreover, lying between a substrate having a glass function, in particular a plastic substrate, and a layer TCC₁ or TCC₂ may be a layer or a multilayer stack, this layer or stack being chosen independently from inorganic, organic and organic-inorganic hybrid layers and having been deposited on the substrate before the associated layer TCC₁ or TCC₂ has been deposited, in particular so as to improve the adhesion of the TCC₁ or TCC₂ to the substrate or to provide an additional function, such as gas impermeability and moisture impermeability. As an example of such an intermediate layer, mention may be made of an Si₃N₄ or SiO₂ layer, which acts in particular as a moisture and oxygen barrier.

In accordance with a first variant, the electroactive system (EA) may comprise a self-supporting polymer matrix into which the electroactive organic compound or compounds (ea₁⁺ and ea₂) and the ionic charges have been inserted, said polymer matrix containing within it a liquid (L) dissolving said ionic charges but not dissolving said self-supporting polymer matrix, said matrix being chosen so as to provide a percolation path for the ionic charges in order to allow said electroactive organic compounds (ea₁⁺ and ea₂) to undergo said oxidation and reduction reactions, the ionic charges being carried by at least one of said electroactive organic compounds (ea₁⁺ and ea₂) and/or reduced and oxidized species that are respectively associated therewith (ea₁ and ea₂⁺), and/or by at least one ionic salt and/or at least one acid dissolved in said liquid (L) and/or by said self-supporting polymer matrix, and the liquid (L) being formed by a solvent or a solvent mixture and/or by at least one ionic liquid or a molten salt at room temperature, said ionic liquid or molten salt or said ionic liquids or molten salts then constituting a liquid (L) carrying ionic charges, which represent some or all of the ionic charges of said electroactive system.

According to a second variant, the electroactive system may comprise a solution or a gel containing the electroactive organic compounds (ea₁⁺ and ea₂).

The electroactive organic compound or compounds (ea₁⁺) may be chosen from bipyridiniums or viologens, such as 1,1′-diethyl-4,4′-bipyridinium diperchlorate, pyraziniums, pyrimidiniums, quinoxaliniums, pyryliums, pyridiniums, tetrazoliums, verdazyls, quinones, quinodimethanes, tricyanovinylbenzenes, tetracyanoethylene, polysulfides and disulfides, and also all the electroactive polymeric derivatives of the electroactive compounds mentioned above, and the electroactive organic compound or compounds (ea₂) is or are chosen from metallocenes, such as cobaltocenes and ferrocenes, N,N,N′,N′-tetramethylphenylenediamine (TMPD), phenothiazines, such as phenothiazine and dihydrophenazines such as 5,10-dihydro-5,10-dimethylphenazine, reduced methyl-phenothiazone (MPT), Bernthsen's methylene violet (MV), verdazyls and all electroactive polymeric derivatives of the abovementioned electroactive compounds.

The ionic salt or salts may be chosen from lithium perchlorate, trifluoromethanesulfonate or triflate salts, trifluoromethanesulfonylimide salts and ammonium salts; the acid or acids are chosen from sulfuric acid (H₂SO₄), triflic acid (CF₃SO₃H), phosphoric acid (H₃PO₄) and polyphosphoric acid (Hₙ₊₂PₙO₃ₙ₊₁); the solvent or solvents may be chosen from dimethylsulfoxide, N,N-dimethylformamide, N,N-dimethylacetamide, propylene carbonate, ethylene carbonate, N-methyl-2-pyrrolidone (1-methyl-2-pyrrolidinone), γ-butyrolactone, ethylene glycols, alcohols, ketones, nitriles and water; and the ionic liquid or liquids may be chosen from imidazolium salts, such as 1-ethyl-3-methylimidazolium tetrafluoroborate (emim-BF₄), 1-ethyl-3-methylimidazolium trifluoromethanesulfonate (emim-CF₃SO₃), 1-ethyl-3-methylimidazolium bis(trifluoromethyl sulfonyl)imide (emim-N(CF₃SO₂)₂ or emim-TSFI) and 1-butyl-3-methylimidazolium bis(trifluoromethylsulfonyl)imide (bmim-N(CF₃SO₂)₂ or bmim-TSFI).

The self-supporting polymer matrix may be formed by at least one polymer layer in which said liquid has penetrated to the core.

The polymer constituting at least one layer may be a homopolymer or copolymer taking the form of a nonporous film but capable of swelling in said liquid, or taking the form of a porous film, said porous film being possibly capable of swelling in the liquid containing ionic charges, and the porosity of said film after swelling is chosen so as to allow the ionic charges to percolate through the thickness of the liquid-impregnated film.

The polymeric material constituting at least one layer may also be chosen from:
homopolymers or copolymers containing no ionic charges, in which case said charges are carried by at least one aforementioned electroactive organic compound and/or by at least one ionic salt or acid in solution and/or by at least one ionic liquid or molten salt;
homopolymers or copolymers containing ionic charges, in which case additional charges for increasing the rate of percolation may be carried by at least one aforementioned electroactive organic compound and/or by at least one ionic salt or acid in solution and/or by at least one ionic liquid or molten salt; and
blends of at least one homopolymer or copolymer not containing ionic charges and of at least one homopolymer or copolymer containing ionic charges, in which case additional charges for increasing the rate of percolation may be carried by at least one aforementioned electroactive organic compound and/or by at least one ionic salt or acid in solution and/or by at least one ionic liquid or molten salt.

The polymer matrix may be formed by a film based on a homopolymer or copolymer containing ionic charges, able by itself to give a film essentially capable of ensuring that the desired rate of percolation for the electroactive system or a higher rate of percolation than that is obtained, and on a homopolymer or copolymer, which may or may not contain ionic charges, able by itself to give a film not necessarily ensuring that the desired rate of percolation is obtained but essentially capable of providing mechanical strength, the contents of each of these two homopolymers or copolymers being regulated so as to ensure that both the desired rate of percolation and the mechanical strength of the resulting self-supporting organic active medium are obtained.

The polymer or polymers of the polymer matrix not containing ionic charges may be chosen from the following: copolymers of ethylene, vinyl acetate and optionally at least one other comonomer, such as ethylene-vinyl acetate (EVA) copolymers; polyurethane (PU); polyvinyl butyral (PVB); polyimides (PI); polyamides (PA); polystyrene (PS); polyvinylidene fluoride (PVDF); polyetheretherketone (PEEK); polyethylene oxide (PEO); epichlorohydrin copolymers; and polymethyl methacrylate (PMMA); and

the polymer or polymers of the polymer matrix containing ionic charges, or polyelectrolytes, may be chosen from sulfonated polymers that have undergone an exchange of the H⁺ ions of the SO₃H groups by the ions of the desired ionic charges, this ion exchange taking place before and/or simultaneously with the swelling of the polyelectrolyte in the liquid containing ionic charges, the sulfonated polymers being especially chosen from sulfonated tetrafluoroethylene copolymers, sulfonated polystyrenes (PSS), sulfonated polystyrene copolymers, poly(2-acrylamido-2-methyl-1-propanesulfonic acid) (PAMPS), sulfonated polyetheretherketones (PEEK) and sulfonated polyimides.

The electrically controllable device of the present invention may also possess current leads at the respective layers TCC₁ and TCC₂ consisting of conductive strips applied to the layers TCC₁ and TCC₂. The conductive strip may be a metal, an alloy or an electrically conductive composite which is deposited directly on the substrates covered with a conductive layer or on the spacers using, for example, a vacuum deposition technique or a screen printing technique with a metal paste, or else which is soldered to the substrates covered with a conductive layer or on the spacers or else which is bonded using an electrically conductive adhesive. The conductive strips of each substrate may be continuous or discontinuous and connected together and may be applied to all or part of each substrate. According to a preferred embodiment of the invention, the current leads are formed from continuous conductive strips applied to the layers TCC₁ and TCC₂ and placed along the entire perimeter or substantially along the entire perimeter of said conductive layers (TCC₁ and TCC₂).

The electrically controllable device of the present invention is especially configured to form: a motor vehicle roof, which is activatable autonomously, or a side window or rear window for a motor vehicle or a rearview mirror; a windshield or a portion of a windshield for a motor vehicle or for an airplane or for a ship; an automobile roof; an airplane window; a panel for displaying graphical and/or alpha-numeric information; interior or exterior architectural glazing; a skylight; a shop counter or display case; glazing for the protection of an object of the painting type; a computer antidazzle screen; glass furniture; a wall separating two rooms inside a building.

To better illustrate the subject of the present invention, two particular embodiments thereof will be described in greater detail below, with reference to the appended drawing.

In this drawing:

FIG. 1 is a schematic view of one face of glazing according to the first prior art document;

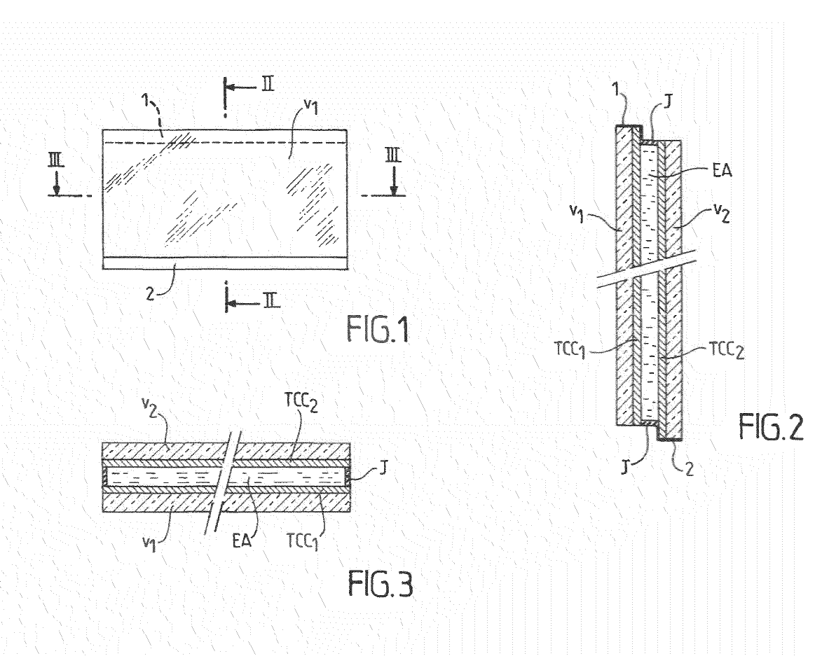

FIGS. 2 and 3 are schematic sectional views on II-II and III-III of FIG. 1 respectively;

FIGS. 4 and 5 are schematic sectional views of two variants of glazing according to the aforementioned French Patent Application 08/58289, representing the second prior art document cited;

FIG. 6 is a sectional view on VI-VI of FIG. 5;

FIGS. 7 and 8 are schematic views illustrating, for comparison, the development of coloration, depicted symbolically by color rectangles, according to the first prior art document cited above and according to the invention respectively;

FIGS. 9 and 10 are schematic views illustrating, for comparison, the depicted development of coloration according to the second prior art document cited above and according to the present invention; and

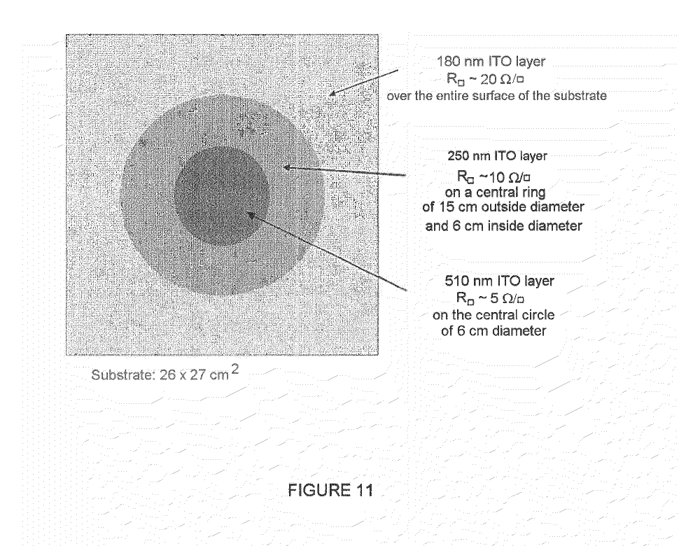

FIG. 11 is a schematic front view of a glass having an ITO layer used according to examples 2 and 4, showing the three different regions of this layer that vary according to the value R_{□}.

FIGS. 1 to 3 show that the glazing represented therein comprises two glass plates V₁, V₂ placed facing each other, one being downwardly offset in order to meet objectives of mounting the glazing in the frame of the rearview mirror. The internal faces of each of these plates V₁, V₂ are coated with an electronically conductive layer, TCC₁ and TCC₂ respectively, formed in particular by a TCO (transparent conductive oxide). Between the two facing regions of the plates V₁, V₂ thus coated is a “reservoir” zone filled with an electroactive medium EA, in solution or gelled form, this reservoir being sealed all around its periphery by an electrically insulating encapsulation seal J.

The current leads for the layers TCC₁, TCC₂ respectively are produced by shims 1, 2 respectively, each formed by an L-shaped metal strip, one of the branches of which is applied to the edge of the coated glass V₁, V₂ and the other branch of which is applied against that part of the layer TCC₁, TCC₂ extending beyond the “reservoir” part. The shims 1, 2 are applied along the upper border and along the lower border of the rearview mirror respectively.

In the following explanation, 1,1′-diethyl-4,4′-bipyridinium diperchlorate (electrochromic) is chosen as compound ea₁⁺ and 5,10-dihydro-5,10-dimethylphenazine (electrochromic) or ferrocene (nonelectrochromic or counterelectrode not participating in the coloring process of the system) is chosen as compound ea₂.

In an ideal system, where no voltage is applied to the device, the active medium containing the ea₁⁺ and ea₂ species is colorless and, when a voltage is applied, the ea₁⁺ species are reduced to ea₁ species, these being uniformly distributed in the vicinity of the surface of the electronically conductive layer connected to the negative pole of the power supply, i.e. connected to the cathode of the glazing, and, likewise, the ea₂ species are oxidized to ea₂⁺ species, these being uniformly distributed in the vicinity of the surface of the electronically conductive layer connected to the positive pole of the power supply, i.e. connected to the anode of the glazing, the panel then appearing with a uniform color corresponding to the uniform mixing of the ea₁ and ea₂⁺ species.

However, in reality it turns out that, when an electrical current is applied and when this current is cut off, a phase segregation phenomenon occurs between the pairs of species (ea₁, ea₁⁺) and (ea₂, ea₂⁺) and especially between the ea₁ and ea₂⁺ species. This phenomenon decreases over the course of time once the bleaching process has been started or during the coloration obtained after the poles of the power supply have been reversed, which phenomenon however may still remain for a very long time, or even still remain when a new command to change the state of the electrically controllable device is applied, so that, in this case, the desired uniform colors are never obtained, whether in the colored state or in the bleached state.

This segregation phenomenon is due to the preferential reduction of the ea₁⁺ species to ea₁ species toward the higher current density zone of the cathode and, conversely, due to the preferential oxidation of the ea₂ species to ea₂⁺ species toward the higher current density zone of the anode, these two higher current density zones being those of the shims. FIG. 7 of the appended drawing, the upper part of which shows schematically a cross section of the known electrically controllable device and the lower part of which, a front view of the panel with voltage applied, illustrates this phenomenon, showing the zones of ea₁ and ea₂⁺ accumulation when voltage is applied to the electrically controllable device and, as a consequence, the appearance of a color mainly due to the ea₁ species toward the cathode (on the right in the front view), this color becoming progressively degraded, to a new color mainly due to the ea₂⁺ species toward the anode (on the left in the front view).

Moreover, the segregation phenomenon is greater the larger the size of the panel of the electrically controllable device and, at the present time, prevents large electrically controllable devices, such as electrically controllable architectural glazing, from being commercially exploited.

Referring to FIGS. 4 to 6, these show glazing according to French Patent Application 08/58289, which comprises two opposed glass sheets V₁, V₂ each coated with their layers TCC₁ and TCC₂, respectively, separated by a double-sided adhesive spacer frame 3 with a polyester core and sealed by an external encapsulation seal J. The frame 3 and the two coated glass sheets define the internal space for accommodating the medium EA.

A conductive current lead strip is applied to each of the coated glass sheets, this strip having a length 1 along one border as in the case of the prior art shown in FIGS. 1 to 3, but being extended by three successive lengths 1a, 1b and 1c and 2a, 2b and 2c respectively, each in the vicinity of one of the three remaining borders.

The aforementioned thin strips are folded on themselves, each time through 90°, at the corners. They are located with regard to the spacer frame 3 by facing each other in the embodiment shown in FIG. 4 but slightly offset from each other in the embodiment shown in FIG. 5.

The assembly of the glazing unit and the encapsulation of the medium EA are carried out conventionally, the current lead strips having been soldered or bonded beforehand to the perimeter of the corresponding coated glass sheet.

The following examples illustrate the present invention without however limiting its scope. In these examples, the following abbreviations have been used:
PVDF: polyvinylidene fluoride;
ITO: tin-doped indium oxide In₂O₃:Sn;
PET: polyethylene terephthalate.

The glass “K-glass®” used in the examples is a glass covered with an electroconductive SnO₂:F layer (glass sold under this name by the company Pilkington).

The glass “VG40” used in the examples is a tinted glass having a light transmission T_{L} of 54%, from the Venus Thermocontrol® range by Saint-Gobain Sekurit.

To produce the PVDF films, polyvinylidene fluoride powder manufactured by the company Arkema under the name “Kynarflex® 2821” was used.

In the Tables:
T_{L} (bleached) denotes the light transmission of the bleached specimen after a zero voltage has been applied for 3 minutes, this transmission being averaged over the visible spectrum, i.e. between 380 nm and 780 nm, and measured on a Minolta 3700D spectrometer;
T_{L} (colored) denotes the light transmission of the colored specimen after a voltage of 1.5 V has been applied for three minutes, this transmission being averaged over the visible spectrum, i.e. between 380 nm and 780 nm, and measured on a Minolta 3700D spectrometer;
the bleaching time is the time needed to switch from T_{L} (colored) to T_{L} (colored)+90%×(T_{L} (bleached)−T_{L} (colored)); and
the coloration time is the time needed to switch from T_{L} (bleached) to T_{L} (bleached)−90%×(T_{L} (bleached)−T_{L} (colored)).

### EXAMPLE 1 (COMPARATIVE EXAMPLE)

### Production of an Electrochromic Cell

K-glass® plate with R_{□}=20.5Ω/□;
Electroactive system: PVDF+ferrocene+1,1′-diethyl-4,4′-bipyridinium diperchlorate+lithium triflate+propylene carbonate;
K-glass® plate with R_{□}=20.5Ω/□;
Current lead strip soldered to the K-glass® plate over the entire periphery of each K-glass® plate according to the configuration shown in FIG. 6.

A self-supporting PVDF film was produced by mixing 6.5 g of PVDF powder with 13.0 g of dibutyl phthalate, 0.5 g of nanoporous silica and 25 g of acetone. The formulation was stirred for 2 hours and cast on a glass plate. After solvent evaporation, the PVDF film was removed from the glass plate under a stream of water. The film thus obtained had a thickness of about 200 μm.

An electroactive solution was prepared by mixing 0.17 g of ferrocene, 0.37 g of 1,1′-diethyl-4,4′-bipyridinium diperchlorate and 0.28 g of lithium triflate in 30 ml of propylene carbonate. The solution was stirred for 1 hour.

The approximately 200-micron thick PVDF film was immersed for 5 minutes in diethyl ether (to dissolve the dibutyl phthalate) and then for 5 minutes in the electroactive solution before being deposited on a K-glass® plate. A second K-glass® plate was deposited on the electrolyte-impregnated film, a PET frame was used as spacer around the electroactive medium, and clips were used to ensure good contact between the glass and the film.

The electrochromic device thus produced had an active surface of 22×23 cm² area and its performance characteristics are given in Table 1 below:

TABLE 1

| | | Bleaching | | Coloration |
|---|---|---|---|---|
| | T_{L} (bleached) | time | T_{L} (colored) | time |
| At the | 75.85% | 44 s | 11.2% | 31 s |
| center of | | | | |
| the active | | | | |
| surface | | | | |
| On the | 75.11% | 40 s | 6.93% | 17 s |
| border of | | | | |
| the active | | | | |
| surface, | | | | |
| close to | | | | |
| the cathode | | | | |

### EXAMPLE 2 (ACCORDING TO THE INVENTION)

### Production of an Electrochromic Cell

Glass plate with an ITO layer having regions of differed R_{□}: 20, 10 and 5Ω/□, as illustrated in FIG. 11;
Electroactive system of Example 1;
Glass plate with an ITO layer having regions of differed R_{□}: 20, 10 and 5Ω/□, as illustrated in FIG. 11;
Current lead strip soldered to the K-glass® plate over the entire periphery of each K-glass® plate according to the configuration shown in FIG. 6.

An ITO conductive layer was produced with a variable surface resistance by carrying out three ITO depositions on the same substrate by magnetron sputtering.

During the first deposition, the ITO was deposited over the entire surface of the substrate and the deposited thickness of 180 nm provided an R_{□}˜20Ω/□.

During the second deposition, a PET mask was used to protect the substrate except for a central circle of 15 cm in diameter. The thickness deposited during this second deposition was 90 nm, enabling an R_{□}˜10Ω/□ to be achieved at the center of the substrate.

During the third deposition, a PET mask was used to protect the substrate with the exception of a central circle of 6 cm in diameter. The thickness deposited during this third deposition was 240 nm, enabling an R_{□}˜5Ω/□ to be achieved at the center of the substrate.

An electrochromic device having an active surface of 22×23 cm² area was produced as described in Example 1, the performance characteristics of which are given in Table 2 below:

TABLE 2

| | | Bleaching | | Coloration |
|---|---|---|---|---|
| | T_{L} (bleached) | time | T_{L} (colored) | time |
| At the | 64.89% | 35 s | 4.13% | 13 s |
| center of | | | | |
| the active | | | | |
| surface | | | | |
| On the | 65.92% | 36 s | 4.58% | 12 s |
| border of | | | | |
| the active | | | | |
| surface, | | | | |
| close to | | | | |
| the cathode | | | | |

### EXAMPLE 3 (COMPARATIVE EXAMPLE)

### Production of an Electrochromic Cell

K-glass® plate with R_{□}=20.5Ω/□;
Electroactive system: PVDF+5,10-dihydro-5,10-dimethylphenazine+1,1′-diethyl-4,4′-bipyridinium diperchlorate+lithium triflate+propylene carbonate;
K-glass® plate with R_{□}=20.5Ω/□;
Current lead strip soldered to the K-glass® plate over the entire periphery of each K-glass® plate according to the configuration shown in FIG. 6.

An electroactive solution was prepared by mixing 0.25 g of 5,10-dihydro-5,10-dimethylphenazine, 0.50 g of 1,1′-diethyl-4,4′-bipyridinium diperchlorate and 0.47 g of lithium triflate in 20 ml of propylene carbonate. The solution was stirred for 1 hour.

An electrochromic device was produced having an active surface of 22×23 cm² area as described in Example 1, the performance characteristics of which are given in Table 3 below:

TABLE 3

| | | Bleaching | | Coloration |
|---|---|---|---|---|
| | T_{L} (bleached) | time | T_{L} (colored) | time |
| At the | 73.02% | 60 s | 0.09% | 44 s |
| center of | | | | |
| the active | | | | |
| surface | | | | |
| On the | 72.83% | 52 s | 0.03% | 12 s |
| border of | | | | |
| he active | | | | |
| surface, | | | | |
| close to | | | | |
| the cathode | | | | |

### EXAMPLE 4 (ACCORDING TO THE INVENTION)

### Production of an Electrochromic Cell

Glass plate with an ITO layer with R_{□} varying between 20, 10 and 5Ω/□ of Example 2;
Electroactive system of Example 2;
Glass plate with an ITO layer with R_{□} varying between 20, 10 and 5Ω/□, of Example 2;
Shims soldered to the entire perimeter of the coated glass plates;
Current lead strip soldered to the K-glass® plate over the entire periphery of each K-glass® plate according to FIGS. 4 and 5.

An electrochromic device having an active surface of 22×23 cm² area was produced as described in Example 1, the performance characteristics of which are given in Table 4 below:

TABLE 4

| | | Bleaching | | Coloration |
|---|---|---|---|---|
| | T_{L} (bleached) | time | T_{L} (colored) | time |
| At the | 63.67% | 46 s | 0.02% | 11 s |
| center of | | | | |
| the active | | | | |
| surface | | | | |
| On the | 64.45% | 44 s | 0.02% | 10 s |
| border of | | | | |
| the active | | | | |
| surface, | | | | |
| close to | | | | |
| the cathode | | | | |

1-17. (canceled)

18: An electrically controllable device having variable optical/energy properties, comprising a multilayer stack comprising:
a first substrate having a glass function;
a first electronically conductive layer with an associated current lead;
an electroactive system comprising:
at least one electroactive organic compound capable of being reduced and/or of accepting electrons and cations acting as compensating charges;
at least one electroactive organic compound capable of being oxidized and/or of ejecting electrons and cations acting as compensating charges;
at least one of the electroactive organic compounds being electrochromic to obtain a color contrast; and
ionic charges capable, under action of an electrical current, of causing the electroactive organic compounds to undergo oxidation and reduction reactions, to obtain a color contrast;
a second electronically conductive layer with an associated current lead; and
a second substrate having a glass function;
wherein each of the first and second electronically conductive layers is chosen to have a resistance R_{□} per unit area enabling it to have an equipotential surface in coloring mode and bleaching mode, each of the first and second electronically conductive layers having a variable resistance R_{□} that gradually decreases from a periphery toward an interior of the electrically controllable device by choosing R_{□} at the center of the glazing, in a zone or zones furthest away from the current leads, so that the ohmic drop over the central surface of the substrates of the glazing, in the zone or zones furthest away from the current leads, is at most equal to 5% of a voltage applied across the terminals of the device.

19: The electrically controllable device as claimed in claim 18, wherein the two facing first and second electronically conductive layers are identical.

20: The electrically controllable device as claimed in claim 18, wherein the first and second electronically conductive layers have a variable resistance R_{□} that gradually decreases in a progressive manner along a gradient.

21: The electrically controllable device as claimed in claim 18, wherein the first and second electronically conductive layers have a variable resistance R_{□} that gradually decreases in zones.

22: The electrically controllable device as claimed in claim 18, wherein one of the first and second electronically conductive layers of variable resistance R_{□} has a resistance that goes from 20Ω/□ or more on the periphery to 5Ω/□ or less at the center of the layer.

23: The electrically controllable device as claimed in claim 18, wherein one of the first and second electronically conductive layer takes a form of a continuous layer or a form of a grid or a microgrid, or a form of grids or of a microgrid that is coated with a continuous layer.

24: The electrically controllable device as claimed in claim 20, wherein one of the first and second electronically conductive layer having a variable resistance R_{□} is obtained: by a plasma, flame, or ablation treatment of the material of the layer for the conductivity of the layer to be progressively degraded or to be degraded in zones; by carrying out successive deposition operations, or in a vacuum, in which conductive material is deposited on the glass substrate, a first deposition being carried out over an entire surface of the substrate, a next deposition then being carried out on a central region thereof, with masking of the peripheral region, and so on if other zones have to be formed, it being possible for the deposition operations other than the first one to be carried out on circular regions so that the various zones of the layer are concentric zones, the center of which corresponds to that of the substrate; or by an array of conductive and/or insulating features, whether identical or different, which are formed on at least one part of the conductive layer deposited on the substrate.

25: The electrically controllable device as claimed in claim 18, wherein the electronically conductive layers are metal layers, or of silver, gold, platinum or copper layers; transparent conductive oxide (TCO) layers, or tin-doped indium oxide (In₂O₃:Sn or ITO), antimony-doped indium oxide (In₂O₃:Sb), fluorine-doped tin oxide (SnO₂:F) and aluminum-doped zinc oxide (ZnO:Al) layers; or multilayers of TCO/metal/TCO type, the TCO and the metal being chosen from those listed above; or multilayers of NiCr/metal/NiCr type, the metal being chosen from those listed above.

26: The electrically controllable device as claimed in claim 18, wherein the first and second electronically conductive layers are each connected to a current lead formed by a conductive strip applied to the associated layer, it being possible for the conductive strip to be a metal, an alloy or an electrically conductive composite which is deposited directly on the substrate covered with its conductive layer or on a spacer separating the two spacer substrates using, a vacuum deposition technique or a screen printing technique with a metal paste, or soldered to the substrate covered with its conductive layer or on a spacer separating the two substrates or else which is bonded using an electrically conductive adhesive, it being possible for the conductive strip applied to a substrate to be continuous or to have discontinuous regions that are connected together and for it to be applied on all or part of each substrate.

27: The electrically controllable device as claimed in claim 26, wherein the current leads comprise continuous conductive strips applied to the first and second electronically conductive layers and placed over an entire perimeter or substantially over an entire perimeter of the electronically conductive layers.

28: The electrically controllable device as claimed in claim 18, wherein the substrates having a glass function are chosen from glass and transparent polymers, or from polymethyl methacrylate (PMMA), polycarbonate (PC), polyethylene terephthalate (PET), polyethylene naphthoate (PEN), and cycloolefin copolymers (COCs).

29: The electrically controllable device as claimed in claim 18, wherein lying between a substrate having a glass function, or a plastic substrate, and a first and second electronically conductive layer is a layer or a multilayer stack, this layer or stack being chosen independently from inorganic, organic, and organic-inorganic hybrid layers and having been deposited on the substrate before the associated electronically conductive layer has been deposited, or so as to improve adhesion of the electronically conductive layer to the substrate or to provide an additional function, or gas impermeability and moisture impermeability.

30: The electrically controllable device as claimed in claim 18, wherein the electroactive system comprises a self-supporting polymer matrix into which the electroactive organic compound or compounds and the ionic charges have been inserted, the polymer matrix containing within it a liquid dissolving the ionic charges but not dissolving the self-supporting polymer matrix, the matrix being chosen so as to provide a percolation path for the ionic charges to allow the electroactive organic compounds to undergo the oxidation and reduction reactions, the ionic charges being carried by at least one of the electroactive organic compounds and/or reduced and oxidized species that are respectively associated therewith, by at least one ionic salt and/or at least one acid dissolved in the liquid and/or by the self-supporting polymer matrix, and the liquid being formed by a solvent or a solvent mixture and/or by at least one ionic liquid or a molten salt at room temperature, the ionic liquid or molten salt or said ionic liquids or molten salts then constituting a liquid carrying ionic charges, which represent some or all of the ionic charges of the electroactive system.

31: The electrically controllable device as claimed in claim 18, wherein the electroactive system comprises a solution or a gel containing the electroactive organic compounds.

32: The electrically controllable device as claimed in claim 18, wherein the electroactive organic compound or compounds is or are chosen from bipyridiniums or viologens, 1,1′-diethyl-4,4′-bipyridinium diperchlorate, pyraziniums, pyrimidiniums, quinoxaliniums, pyryliums, pyridiniums, tetrazoliums, verdazyls, quinones, quinodimethanes, tricyanovinylbenzenes, tetracyanoethylene, polysulfides and disulfides, and also all the electroactive polymeric derivatives of the electroactive compounds mentioned above, and the electroactive organic compound or compounds is or are chosen from metallocenes, or cobaltocenes and ferrocenes, N,N,N′,N′-tetramethylphenylenediamine (TMPD), phenothiazines, or phenothiazine and dihydrophenazines or 5,10-dihydro-5,10-dimethylphenazine, reduced methyl-phenothiazone (MPT), Bernthsen's methylene violet (MV), verdazyls and all electroactive polymeric derivatives of the above-mentioned electroactive compounds.

33: The electrically controllable device as claimed in claim 30, wherein:
the ionic salt or salts are chosen from lithium perchlorate, trifluoromethanesulfonate or triflate salts, trifluoromethane sulfonylimide salts, and ammonium salts;
the acid or acids are chosen from sulfuric acid (H₂SO₄), triflic acid (CF₃SO₃H), phosphoric acid (H₃PO₄), and polyphosphoric acid (Hₙ₊₂PₙO₃ₙ₊₁);
the solvent or solvents are chosen from dimethylsulfoxide, N,N-dimethylformamide, N,N-dimethylacetamide, propylene carbonate, ethylene carbonate, N-methyl-2-pyrrolidone (1-methyl-2-pyrrolidinone), γ-butyrolactone, ethylene glycols, alcohols, ketones, nitriles, and water; and
the ionic liquid or liquids are chosen from imidazolium salts, such as 1-ethyl-3-methylimidazolium tetrafluoroborate (emim-BF₄), 1-ethyl-3-methylimidazolium trifluoromethanesulfonate (emim-CF₃SO₃), 1-ethyl-3-methylimidazolium bis(trifluoromethyl sulfonyl)imide (emim-N(CF₃SO₂)₂ or emim-TSFI), and 1-butyl-3-methylimidazolium bis(trifluoromethylsulfonyl)imide (bmim-N(CF₃SO₂)₂ or bmim-TSFI).

34: The electrically controllable device as claimed in claim 18, configured to form: a motor vehicle roof, which is activatable autonomously, or a side window or rear window for a motor vehicle or a rearview mirror; a windshield or a portion of a windshield for a motor vehicle or for an airplane or for a ship; an automobile roof; an airplane window; a panel for displaying graphical and/or alpha-numeric information; an interior or exterior architectural glazing; a skylight; a shop counter or display case; a glazing for protection of an object of painting type; a computer antidazzle screen; glass furniture; a wall separating two rooms inside a building.
